(19) United States
(12) Patent Application Publication
(10) Pub. No.: US 2014/0054426 A1
(43) Pub. Date: Feb. 27, 2014

(54) FREE STANDING HOLDER FOR A PERSONAL ELECTRONIC DEVICE

(71) Applicant: Don R. Burns, Santa Fe Springs, CA (US)

(72) Inventor: Don R. Burns, Santa Fe Springs, CA (US)

(73) Assignee: Vantage Point Products Corp.

(21) Appl. No.: 14/005,528

(22) PCT Filed: Mar. 15, 2012
(86) PCT No.: PCT/US12/29235

§ 371 Date: Oct. 29, 2013

Related U.S. Application Data
(60) Provisional application No. 61/453,373, filed on Mar. 16, 2011.

(51) Int. Cl. F16M 11/20

(52) U.S. Cl. CPC F16M 11/20
USPC 248/122.1; 248/121

(57) ABSTRACT

An apparatus for holding a personal electronic device is provided. The apparatus includes a holder configured to be fixed to the personal electronic device, and a flexible container adapted to be closed and interconnected to the holder.

### RELATED PATENT APPLICATION

This application claims priority to and the benefit of U.S. Provisional Patent Application No. 61/453,373, entitled “Free Standing Holder for iPAD and Similar Devices”, filed Mar. 16, 2011, which is incorporated herein by reference in its entirety for all purposes.

### BACKGROUND

The present application relates generally to the field of holders for personal electronic devices. More specifically, the present application relates to free standing holders for tablet computers.

Hands free and single handed use of tablet computers and similar devices improves productivity and the functionality of various applications where these personal electronic devices are being used. As a result, stands, mounts, and holders are becoming an important part of the personal electronic device experience. However, conventional stands for personal electronic devices such as tablet computers typically have one or more shortcomings. Some will only work on flat surfaces, free of irregularities and the stability of these stands is usually dependant on the footprint and weight of the stand's base. These stands have a tendency to rock back and forth on uneven surfaces or are easily tipped over if not heavy or large enough. Heavy materials such as steel, if unprotected, tend to dent or damage other materials they come in contact with. Some stands tend to amplify bounce or vibration caused by physical touch or surrounding influences and consequently diminish legibility of screen content. Most stands are not intended to be held, and consequently are not comfortable when placed in a user's lap. Some stands will only hold a device in one orientation, while others do not physically attach to the device they are supporting, rather they simply cradle the device, thereby creating an unstable situation that could allow the device to be inadvertently dislodged from the stand.

### BRIEF DESCRIPTION OF THE DRAWINGS

FIG. 1 is an exploded view of a holding apparatus for a personal electronic device, shown according to an exemplary embodiment.

FIG. 2 is an isometric view of a holder for the holding apparatus of FIG. 1, shown according to an exemplary embodiment.

FIG. 3 is a cross-section view of a portion of the holder of FIG. 2, shown coupled to a personal electronic device, taken along line 3-3.

FIG. 4 is an isometric view of a bag for the holding apparatus of FIG. 1, shown according to an exemplary embodiment.

FIG. 5 is a front view of a panel for the bag of FIG. 4, shown according to an exemplary embodiment.

FIGS. 6A-6B are cross-section views of several of the panels of FIG. 5 coupled together, shown according to an exemplary embodiment.

FIG. 7 is a cross-section view of the bag of FIG. 4, taken along line 7-7.

FIG. 8 is a side view of a hub for the holding apparatus of FIG. 1, shown according to an exemplary embodiment.

FIG. 9 is a bottom isometric view of a hub of FIG. 8.

FIG. 10 is a bottom view of a hub of FIG. 8.

FIGS. 11A-11B are partial cross-section views illustrating the coupling of the hub to the bag of the holding apparatus of FIG. 1, shown according to an exemplary embodiment.

FIG. 12 is an isometric view of the hub coupled to the bag of the holding apparatus of FIG. 1, shown according to an exemplary embodiment.

FIG. 13 is an isometric view of the holding apparatus of FIG. 1, illustrating the cam surfaces of the holder and the hub, shown according to an exemplary embodiment.

FIGS. 14A-14C are bottom views of the holding apparatus of FIG. 1 with the hub in several positions, shown according to an exemplary embodiment.

FIGS. 15A-15C are various views of the holding apparatus of FIG. 1 on a flat surface, shown according to an exemplary embodiment.

FIGS. 16A-16C are various views of the holding apparatus of FIG. 1 on an uneven surface, shown according to an exemplary embodiment.

### DETAILED DESCRIPTION

Referring generally to the Figures, an apparatus for holding a personal electronic device, and components thereof, are shown according to an exemplary embodiment. The holding apparatus is configured to support a personal electronic device at a variety of viewing angles on flat or irregular, hard or soft, rugged or delicate surfaces. For example, the holding apparatus may support the personal electronic device on a table, on a user's lap, wedged in a cupholder, etc. The personal electronic device may be a flat screen electronic device such as a tablet computer (e.g., an Apple iPad, Samsung Galaxy Tab, Amazon Kindle, etc.), a smart phone (e.g., an Apple iPhone, a Windows based smartphone, an Android based smartphone, etc), a laptop computer, a netbook, a personal digital assistant, a camera, a global positioning system (GPS) navigator, diagnostic equipment, etc.

According to one embodiment, the holding apparatus includes a holder and a flexible container adapted to be closed and interconnected to the holder. The holder may be configured to be coupled or fixed to the personal electronic device, and the flexible container may be configured to support the holder. According to the exemplary embodiment described below, the flexible container is filled with a plurality of beans or pellets. The holding apparatus may further include a hub which interconnects the holder and the flexible container. The hub may couple to the holder in an off-center position. According to one embodiment, the hub rotatably couples the flexible container to the holder. According to another embodiment, the hub releasably couples the flexible container to the holder.

According to another embodiment, the holding apparatus includes a bag defining an opening and filled with a plurality of pellets, and a hub coupled to the bag and having a fin extending axially therefrom. The fin is at least partially immersed in the plurality of pellets. The pellets within the bag may inhibit movement of the fin. The hub may couple to a holder configured to support a personal electronic device, and when the holder is placed in a desired or selected position, a reaction force exerted by plurality of pellets on the fin inhibits motion of the holder from the desired or selected position.

According to another embodiment, the holding apparatus includes a holder configured to be fixed to the personal electronic device, a bag, and a hub having a first portion rotatably coupled to the holder and a second portion coupled to the bag. The hub may rotate about an axis parallel to and spaced apart from an axis passing through the center of the personal electronic device. The holder may include a first cam surface, and the hub may comprise a second cam surface. The first cam surface may comprise a first set of at least three lobes, and the second cam surface may comprise a second set of at least three lobes configured to engage the first set of at least three lobes to form at least three detent positions. The at least three detent positions may include a landscape position configured to support the personal electronic device in a landscape orientation and a portrait position configured to support the personal electronic device in a portrait orientation

Before discussing further details of the holding apparatus and/or the components thereof, it should be noted that references to “front,” “back,” “rear,” “upward,” “downward,” “inner,” “outer,” “right,” and “left” in this description are merely used to identify the various elements as they are oriented in the Figures. These terms are not meant to limit the element which they describe, as the various elements may be oriented differently in various applications.

It should further be noted that for purposes of this disclosure, the term coupled means the joining of two members directly or indirectly to one another. Such joining may be stationary in nature or moveable in nature and/or such joining may allow for the flow of fluids, electricity, electrical signals, or other types of signals or communication between the two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

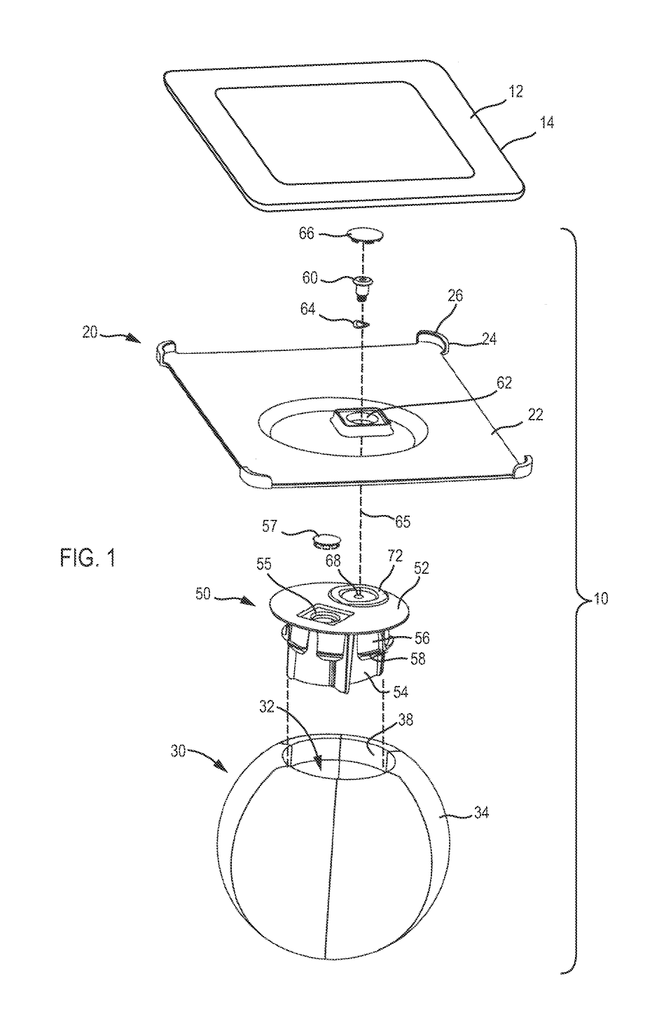

Referring to FIG. 1, a holding apparatus 10 (e.g., mount, holding device, base, support structure, etc.), and components thereof, for a personal electronic device (PED) 12 are shown according to an exemplary embodiment. The holding apparatus 10 is configured to support the PED 12 at a variety of viewing angles on flat or irregular, hard or soft, rugged or delicate surfaces. The holding apparatus 10 includes a holder 20 configured to be fixed (e.g., releasably fixed, unitized to the PED 12 until forcibly removed therefrom, remaining coupled to the PED 12 regardless of orientation of the holder 20 to the PED 12 with respect to gravity, etc.) to the PED 12. The holding apparatus 10 further includes a flexible container (e.g., flexible container adapted to be closed, bean bag, sac, pouch, etc.), shown as a bag 30, configured to support the holder 20. In one embodiment, the bag 30 is coupled to the holder 20 with a hub 50, which is configured to rotatably couple the bag 30 to the holder 20. According to the exemplary embodiment shown, the hub rotates about an axis offset from the center of the holder 20, thereby allowing the position of the bag 30 relative to the holder 20 to be varied and facilitating support of the PED 12 on a surface at a variety of viewing angles and orientations.

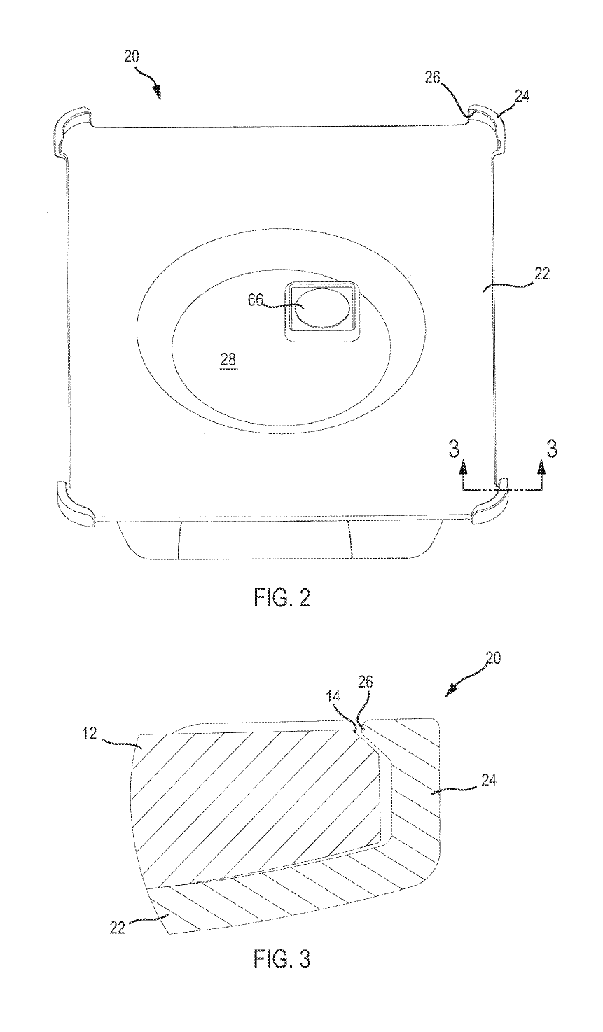

Referring to FIG. 2, the holder 20 (e.g., bracket, mount, etc.) is shown as a rigid body that is configured to be fixed to the back of the PED 12. According to an exemplary embodiment, the holder 20 is formed of a rigid polymer material, such as injection molded of polycarbonate. In other embodiments, the holder may be another polymer material (e.g., polyurethane, polyvinyl chloride (PVC), acrylonitrile butadiene styrene (ABS), etc.), a metal or metal alloy (e.g., an aluminum alloy, etc.), or a composite material. The holder 20 includes a main body 22. As shown, main body 22 is generally planar and rectangular, and has two or more projections 24 that extend upward from the main body. As shown in FIG. 2, projections 24 are provided on each of the four corners of the main body 22. The projections 24 and/or the edges of the main body 22 may be contoured similarly to the back surface of the PED 12. The projections 24 may include openings (e.g., holes, apertures, slots, etc.) (not shown) to allow access to various ports, buttons, switches, vents, or other features of the PED 12 provided along the sides of the PED 12 proximate to the projections 24. According to other embodiments, the projections 24 may be configured to grasp the PED 12 along two or more sides instead of, or in addition to, at corners.

Referring to FIG. 3, the projections 24 each include an inwardly extending lip 26 that wraps over a front edge 14 of the PED 12. The projections 24 have a compliance sufficient to allow a user to couple the PED 12 to the holder by pressing the PED 12 against the holder 20 until the lips 26 engages (e.g., clips, snaps, couples, etc.) around the front edge 14 of the PED 12. The PED 12 is therefore retained on the holder 20 via the projections 24, which impede movement of the PED 12 in any direction parallel to the surface of the main body 22 (e.g., the x and y-directions), and the lips 26, which impede movement of the PED 12 in a direction perpendicular to the surface of the main body 22 (e.g., the z-direction). The projections 24 have a compliance that is sufficient to retain the PED 12 to the holder 20 against the weight of the PED 12 and any incidental forces that may be applied to the holding apparatus 10, but still allow the user to remove the PED 12 by applying a sufficient force to overcome the lips 26 (e.g., to deflect the lips 26 and the projections 24 beyond the edge 17 such that the edge 17 may pass thereby).

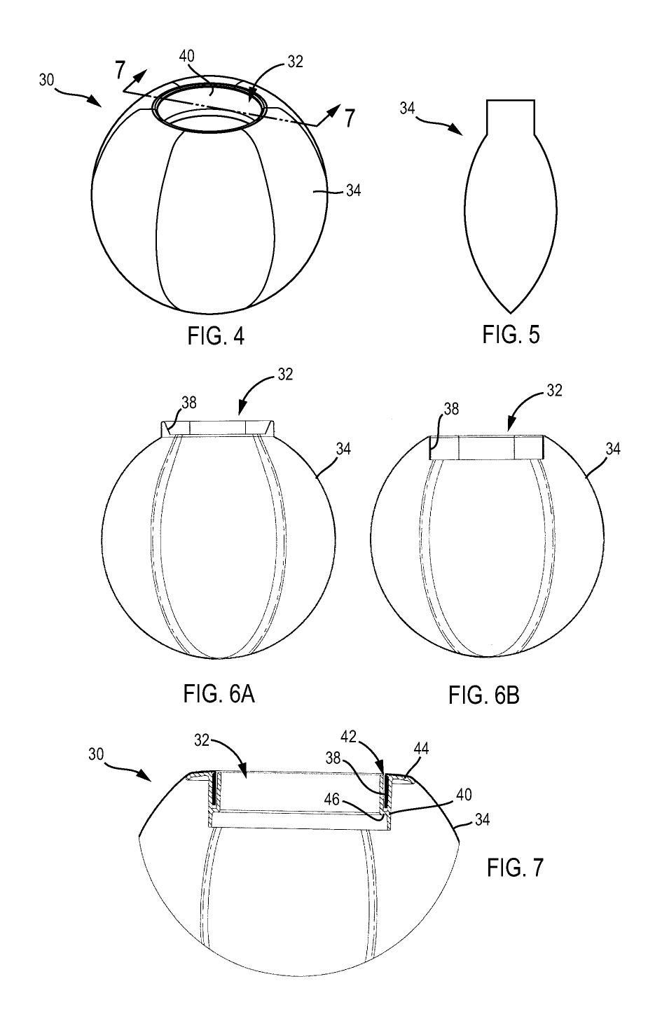

Referring to FIGS. 4-7, the bag 30 is shown according to an exemplary embodiment. The bag 30 provides a flexible, adaptable base for the holder 20. The bag 30 has an aspect ratio of a first dimension extending normal to the personal electronic device (e.g. height, elevational profile, etc.) versus a second dimension transverse to the first dimension (e.g., width, transverse diameter, plan profile, etc.). According to one embodiment, the first dimension is at least one-half the second dimension, i.e., the aspect ratio is greater than 1:2. According to one embodiment, the aspect ratio is approximately 1:1. According to one embodiment, the bag 30 is substantially spherical. According to other embodiments, the bag 30 is substantially cubic, substantially polyhedronal, substantially cylindrical, or may be any combination thereof. Having an aspect ratio greater than 1:2 facilitates positioning and orienting the holding apparatus 10 and PED 12 at desired angles. For example, an aspect ratio of greater than 1:2 facilitates supporting the PED 12 at a steeper angle relative to the surface. The size (e.g., diameter, height, width, etc.) of the bag 30 is related to the size of the PED 12. In an exemplary embodiment, the bag 30 has a diameter of approximately 15 cm (6 inches) in relation to a screen of approximately 25 cm (9.7 inches). According to various other embodiments, the bag 30 may be larger or smaller (e.g., a diameter of approximately 6 cm (2.3 inches) for a holding apparatus configured for a smartphone).

According to an exemplary embodiment, the bag 30 is formed of (e.g., cut from, made of, etc.) a substantially inelastic material (e.g., furniture quality synthetic suede, cloth, leather, synthetic leather, etc.). In other embodiments, the bag 30 may be formed from an elastic or semi-elastic material (e.g. spandex, elastane, thin-walled latex, etc.). Forming the bag 30 of a substantially inelastic material helps restrict the movement (e.g., interlock, lock up, bind up, etc.) of the fill material disposed in the bag 30. Furthermore, a substantially inelastic material resists stretching of bag, which would allow the fill material to be pushed or displaced by the weight of the apparatus 10 and the PED 12, which in turn would reduce the stability of the bag 30 and the ability of the apparatus 10 to hold the PED 12 in a selected position. That is, as the fill material is pushed outward (e.g., in response to the weight of the holder 20, PED 12, forces applied to the PED 12 by the user, etc.), and the outward force is transformed into a hoop stress (e.g., cylindrical stress, circumferential stress, etc.) in the bag 30. A substantially inelastic material may resist deformation under the resulting hoop stresses, thereby providing stability to the apparatus 10. In contrast an elastic material may deform under the resulting hoop stresses, and furthermore the deformation may vary with load, which may lead to instability of the apparatus 10.

An exemplary method of manufacturing the bag 30 is described; however, it must be noted that other methods of producing the bag 30 are contemplated and fall within the scope of the apparatus as claimed and described herein. The bag 30 is formed from multiple generally leaf-shaped panels 34 sewn together to form a generally spherical bag 30 with an open end 32. The panels 34 are sewn together inside out and then the bag 30 is inverted (i.e., turned right side out). The panels 34 form a generally cylindrical neck 38 that may be folded in on itself and stitched to have a double thickness approximately 0.2 cm (0.5 inch) tall, as shown in FIG. 6A. According to the exemplary production method, the neck 38 is inverted and pushed into the open end 32 of the bag 30, as shown in FIG. 6B.

A retaining ring 40 may be coupled to the open end 32 of the bag 30 to add rigidity and to provide a mounting structure for the hub 50. According to an exemplary embodiment, the retaining ring 40 may be formed of a similar material as the holder 20 (e.g., an injection molded high impact plastic such as polycarbonate, PVC, ABS, etc.). The retaining ring 40 is inserted through the open end 32 of the bag 30 and the inverted neck 38 pulled over an outwardly extending flange 44 about the upper end of the retaining ring 40 and inserted into a groove 42 in the retaining ring 40. After the retaining ring 40 is coupled to the bag 30, the bag 30 is then partially filled with a granular fill material (e.g., pellets, beans, beads, rods, balls, salt, sand, media, etc.).

According to an exemplary embodiment, the fill material used to fill the bag 30 is formed of a substantially incompressible material having a non-spherical shape. For example, the fill material comprises plastic pellets (e.g., polyurethane, ABS, HDPE, etc.). For example, the pellets may be similar to the pellets utilized in injection molding machines. In other embodiments, the fill material may be spherical or compressible (e.g., polystyrene foam, other foamed plastics, etc.). A non-spherical (e.g., cylindrical) or irregular shape may reduce the fluidity of the granular material and help the bag 30 to retain a shape to better support the holder 20 in a desired position. A substantially incompressible fill material may improve stability of the apparatus 10 and better hold the PED 12 in a desired position. According to one embodiment, the fill material comprises pellets having a cross-sectional dimension (e.g., diameter, width, etc.) of less than 2 cm (0.5 inch).

The weight of the fill material contributes to the weight of the holding apparatus 10, which is preferably configured to be greater than or substantially equal to a weight of the PED 12. Having the weight of the holding apparatus 10 greater than or substantially equal to a weight of the PED 12 brings the combined center of gravity of the holding apparatus 10 and PED 12 towards the holding apparatus 10, thereby reducing the moment arm the combined center of gravity applies to the holding apparatus 10, thus promoting stability of the holding apparatus 10 and facilitating the holding apparatus 10 holding the PED 12 in a desired position (e.g., reducing the force that must be resisted by the fill material). According to an exemplary embodiment, the fill material collectively weighs between 0.6 kg (1.3 pounds) and 0.8 kg (1.8 pounds). According to a preferred embodiment, the fill material collectively weighs approximately 0.7 kg (1.5 pounds).

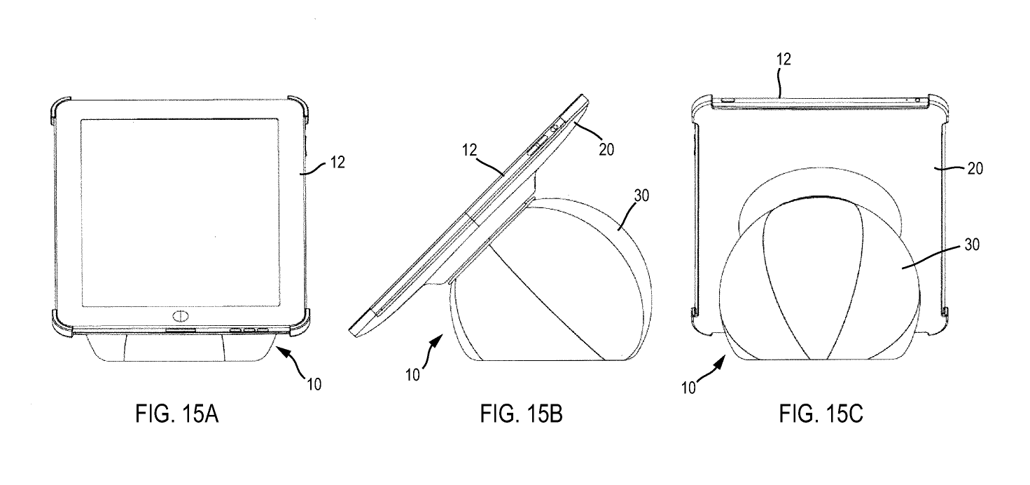

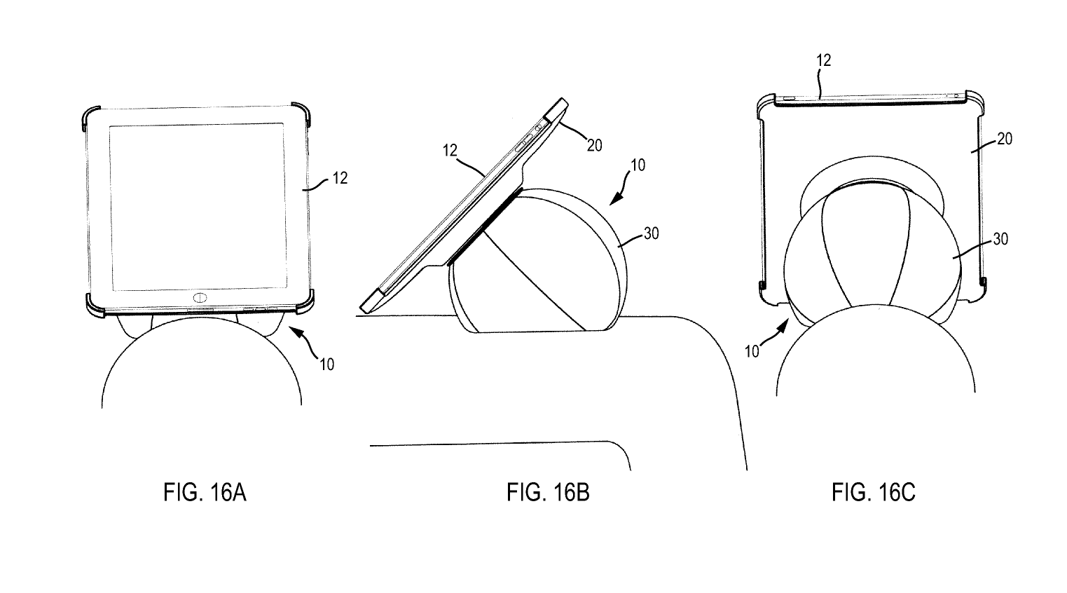

According to an exemplary embodiment, the bag 30 is filled between 85% and 95% of capacity. According to a preferred embodiment, the bag 30 is filled to approximately 90% of capacity). A full bag 30 may resist deformation and, thus, may provide an unstable base for the holder 20. For example, the bottom of a full bag may remain sufficiently round to induce sliding or rolling, rather than deforming or contouring to the support surface to create a more stable base. An under-filled bag 30 may provide insufficient support for the holder 20. For example, an under-filled bag may excessively deform and, thus, permit unwanted motion of the holding apparatus 10. By only partially filling the bag 30, the bag 30 may deform and conform to both flat and irregular surfaces (see FIGS. 15A-16C) while still providing sufficient support to the holder 20 to so that the holding apparatus 10 may retain the PED 12 in a desired orientation.

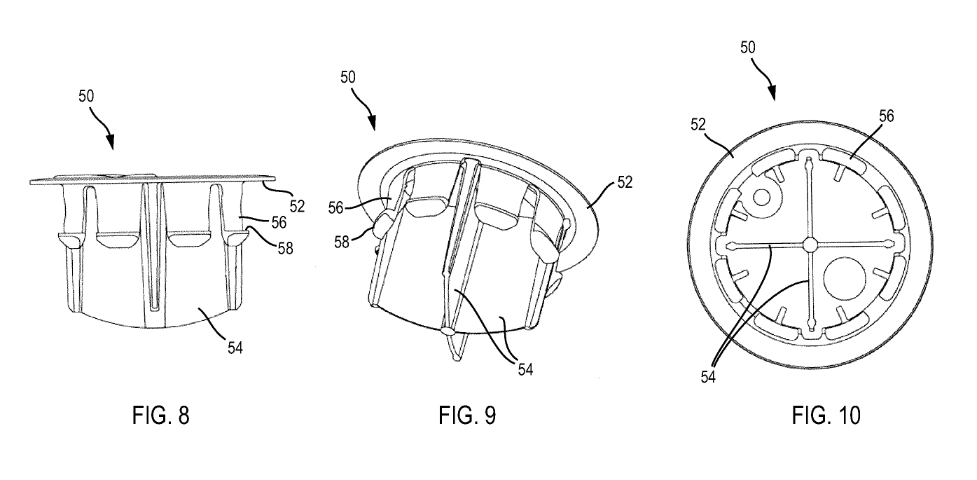

Referring more particularly to FIGS. 8-10, the hub 50 is shown according to an exemplary embodiment. The hub 50 includes an upper portion 52 (e.g., flange, member, structure, plate, web, upper face, etc.) and may include one or more hook tabs 56 that extend downward about the periphery of the upper portion 52. As shown, the upper portion 52 is substantially circular, and the hook tabs 56 are cantilevered bodies with a barbed or hooked end 58 that engages the retaining ring 40 to couple the hub 50 to the bag 30. The hub 50 may be formed of a similar material as the holder 20 (e.g., an injection molded high impact plastic such as polycarbonate, PVC, ABS, etc.).

According to an exemplary embodiment, the hub 50 includes at least one fin 54 (e.g., blade, finger, extension, protrusion, etc.) extending downward from the upper portion 52. When the hub 50 is coupled to the bag 30, the fins 54 are at least partially immersed in the fill material, thereby restricting the movement of the hub 50 and, therefore, the holder 20 and the PED 12. According to one embodiment, when the PED 12, holder 20, or apparatus 10 are placed in a desired position or orientation, the fins 54 are held in place by the reaction forces exerted on the fins 54 by the fill material, the mass of the fill material, and/or the inertia of the fill material and, therefore, inhibit the hub 50, holder 20, and PED 12 from moving. Thus, the PED 12 and holder 20 are held in the desired position. However, due to the granular nature of the fill material, a user may provide sufficient force to move (e.g., shear, slide, etc.) the fins 54 through the media to adjust the position and/or orientation of the holder 20 and PED 12.

The size of the fins 54 is generally a function of the size of the bag 30. That is, the depth of the fins 54 is limited by the diameter of the bag 30. According to an exemplary embodiment, the fins 54 preferably do not contact the wall of the bag 30 during normal operation. However, the deeper the fins 54 are immersed in the fill material, the more the movement of the fins 54 is resisted by the fill material. That is, the fill material can provide a greater reaction force on the fins 54. According to an exemplary embodiment, the fins 54 may have a height of approximately ⅓ the diameter of the bag 30 (e.g., approximately 5 cm (2 inches) for a 15 cm (6 inch) diameter bag 30). According to one embodiment, the fins 54 at least partially inhibit the movement or “flow” of the fill material, thereby synergistically increasing the stability of the bag 30.

In an embodiment having fins 54, a fill material including substantially incompressible pellets may provide a reaction force to the fins 54 rather than being compressed. Further, a fill material including irregularly shaped pellets may provide facets that enable the pellets to engage one another (e.g., lock up, form a lattice, form a matrix, create structure, etc.) to thereby enable a reaction force against the fins 54 rather than flowing around or away from the fins 54. Forming the bag 30 of a substantially inelastic material provides support to the pellets, rather than allowing the pellets to be displaced by the fins 54.

As shown, the hub 50 includes four orthogonal fins 54 arranged radially about the center of the hub 50. In other embodiments, the hub 50 may include more or fewer fins (e.g., one fin, two fins, three fins, five fins, etc.). The fins 54 are shown to be evenly spaced about the center of the hub, but may be unevenly spaced in some embodiments. The fins 54 are shown to extend radially, but according to other embodiments, the fin may not extend radially. For example, the fin 54 may form a cylinder, two or more fins may be arranged along intersecting or parallel planes, or the fins may be arranged to form a star pattern, an I-beam, or a box-beam. Extending the fins 54 along intersecting planes (e.g., extending radially from one or more axes extending downward from the upper portion 52, etc.) allows the fins 54 to interact with the reaction forces of the fill material along different vector component directions, thereby increasing the stability of the hub 50 and providing better support of the holder 20 and PED 12 in more orientations.

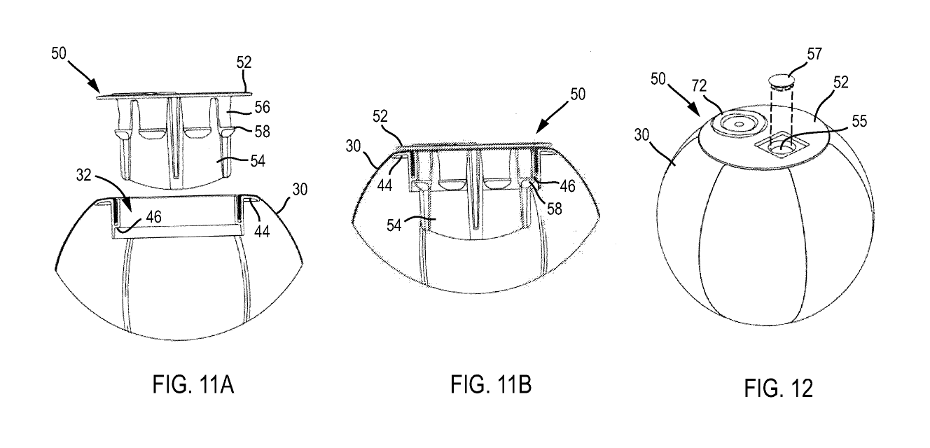

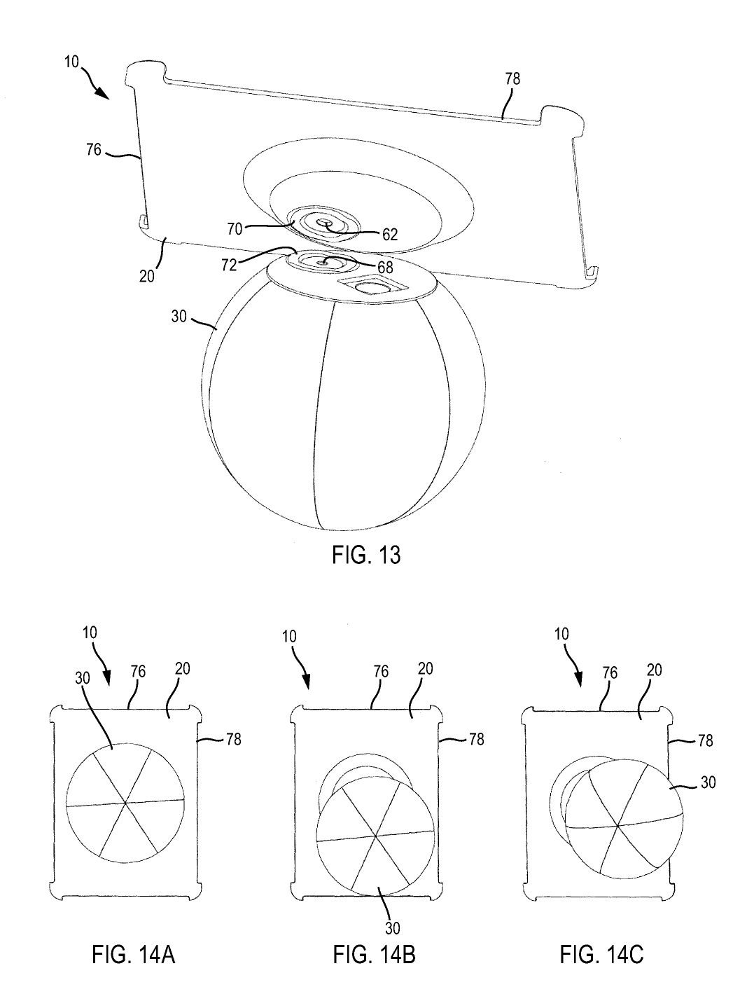

Referring now to FIGS. 11A-12, the hub 50 is coupled to the retaining ring 40 and the bag 30 by inserting the fins 54 and the hook tabs 56 into the open end 32 of the bag 30 through the retaining ring 40. The retaining ring 40 compresses the hook tabs 56 inward. When the hub 50 is fully seated, the hooked ends 58 clear the retaining ring 40 and engage an outwardly extending ledge 46 (e.g., lip, edge, etc.) on the lower end of the retaining ring 40. A portion of the bag 30 is trapped between the flange 44 of the retaining ring 40 and the upper portion 52 of the hub 50. The upper portion 52 closes the open end 32 of the bag 30. According to one embodiment, the fill material is loaded into the bag 30 before the hub 50 is coupled to the bag 30. According to the exemplary embodiment shown, the fill material may be added or removed from the interior of the bag 30 through an access hole 55 in the upper portion 52. A cover 57 (e.g., cap, plug, etc.) couples to the hub 50 and closes the access hole 55. As shown, the cover 57 couples to the hub 50 with a snap fit, but in other embodiments, the cover may be coupled to the hub 50 with a threaded or hinged connection. In still other embodiments, the hub 50 may not include an access hole.

The hub 50 is coupled to the holder 20 with mounting hardware. According to an exemplary embodiment shown in FIG. 1, the mounting hardware includes a fastener, shown as shoulder bolt 60, extending through an opening 62 in a raised portion of a depression 28 in the main body 22 of the holder 20 to engage a threaded opening 68 in the hub 50. The shoulder bolt 60 compresses a resilient member (e.g., a Bellville washer, a curved spring washer, a wave spring washer, etc.), shown as a spring washer 64. The bolt 60 may be covered by a cover 66 (e.g., cap, plug, etc.). The cover 66 may engage the holder 20 with a snap fit, threaded connection, hinged connection, etc., similar to the cover 57. In other embodiments, the cover 66 may coupled to the holder 20 with an adhesive. The holder 20 and the hub 50 rotate on the shoulder bolt 60 about an axis 65 that is parallel to and spaced apart or offset from an axis passing through the center of the personal electronic device.

Referring to FIG. 12, the holder 20 includes a cam surface 70 that engages (e.g., interacts with, couples to, etc.) a corresponding cam surface 72 on the hub 50. The cam surfaces 70 and 72 include detents that are configured to index the relative rotational position of the bag 30 and the holder 20 in at least two positions. According to an exemplary embodiment, the cam surfaces 70 and 72 are annular surfaces disposed around the openings 62 and 68 for the shoulder bolt 60. The cam surfaces 70 and 72 are shown to each include three circumferentially, equally spaced lobes (e.g., tri-lobes spaced 120 degrees apart). The lobes of the first cam surface 70 engage the three lobes of the second cam surface 72 to form at least three detent positions. The first cam surface 70 is biased against the second cam surface 72 by the spring washer 64. It is contemplated that other cam arrangements may be used. For example, one of the cam surfaces 70, 72 may extend radially outward, and the other of the cam surface 70, 72 may extend radially inward. The cam surfaces 70, 72 may have any number of detent positions, and the cam surfaces 70 and 72 may have different numbers of lobes. For example, one of the cam surfaces 70, 72 may have one lobe, and the other of the cam surfaces 70, 72 may have two, three, four, etc., lobes, thereby creating two, three, four, etc., detent positions. It is further contemplated that the detent positions are not equally spaced about the openings 62 and 68.

Referring to the exemplary embodiment shown in FIGS. 14A-14C, the cam surfaces 70 and 72 index the position of the holder 20 relative to the hub 50 and the bag 30 at 120 degree intervals. The bag 30 may therefore be rotated to be relatively centered on the holder 20 (see FIG. 14A), proximate to one of the shorter sides of the holder 20 and the PED 12 (see FIG. 14B), or proximate to one of the longer sides of the holder 20 and the PED 12 (see FIG. 14C). A wide variety of viewing angles and orientations for the PED 12 are therefore possible by moving the holder 20 relative to the bag 30. For example, with the bag 30 in the center position, the holder 20 may be supported in the portrait orientation with the holder 20 at approximately a 45 degree angle relative to the surface (see e.g., FIG. 15B and FIG. 16B). The holder 20 may be oriented at a near 90 degree angle in the portrait orientation by rotating the bag 30 to the position shown in FIG. 14B, or in the landscape orientation by rotating the bag 30 to the position shown in FIG. 14C. Such angles and orientations are exemplary only and it should be understood that the flexible nature of the bag 30 allows for a near infinite number of viewing angles for the PED 12 coupled to the holder 20. For example, the holder 20 and the PED 12 may be oriented substantially parallel (e.g., zero degrees) relative to the surface.

According to one embodiment, with the bag 30 in the center position, the holder 20 and the PED 12 may be supported by the bag 30 at approximately a 60 degree angle relative to the surface. The holder 20 and PED 12 may be rotated (e.g. rolled, revolved about an axis parallel to the surface and extending through the bag 30, etc.) about the bag 30 until the holder 20 and the PED 12 are substantially parallel to the surface. The holder 20 and the PED 12 may continue to the rotated about the bag until the holder 20 and the PED 12 are at approximately a −60 degree angle relative to the surface. That is, what was the relative top portion of the PED 12 is now the relative bottom portion, and what was the relative bottom portion is now the relative top portion. Many personal electronic devices include an accelerometer which is configured to recognize the change in orientation and to adjust the image displayed on the screen accordingly. Thus, the holding apparatus 10 facilitates use (e.g., collaboration, competition, etc.) by users on opposite sides of a table or desk.

The holding apparatus 10 may also permit rotation about a substantially vertical axis passing through the bag 30. Accordingly, the holding apparatus 10 may facilitate use by multiple users on the same side, adjacent sides, or opposite sides of a table or desk. The holding apparatus may also be laterally translated (e.g., slid) along a surface. Further, because the bag 30 is deformable and the holder 20 is fixed to the PED 12, the holding apparatus 10 and the PED 12 may be picked up as a unit and set down on another surface or on another portion of the same surface without regard to the evenness of the surface.

Referring now to FIGS. 15A-16C, the flexible nature of the bag 30 allows the holding apparatus 10 to be able to stably support the PED 12 at a variety of viewing angles and orientations both on a flat surface (e.g., a desktop, a table, a kitchen counter, etc.), as shown in FIGS. 156A-156C, or on an uneven or contoured surface (e.g., a lap, a bed, an arm rest, a cupholder, a dashboard of an automobile, etc.), as shown in FIGS. 16A-16C. In various applications, the apparatus 10 may stably support the PED 12 on uneven or contoured surfaces on machinery, testing equipment, or in an engine compartment. The material of the bag 30 is preferably soft enough to not scratch or otherwise mar a delicate surface, but is rugged enough that the holding apparatus may be utilized on rough surfaces (e.g., concrete, sharp edges, etc.).

While the holding apparatus has been described as having a holder 20 coupled to a bag 30 with a hub 50, in other embodiments, the holder 20 may be coupled to the bag 30 by another means that allows the bag 30 to be decoupled from the holder 20, reoriented relative to the holder 20, and recoupled to the holder 20. For example, the bag 30 may be coupled to the holder 20 using snaps, buttons, fields of mating pins, or a hook and loop fastener (e.g., Velcro). According to one embodiment, the holder 20 includes a first half of a hook and loop fastener pairs. The first half of the hook and loop fastener may, for example using an adhesive, be fixed to the PED 12 or may be fixed to a rigid body which couples to the PED 12, such as the one described above. The second half of the hook and loop fastener may be fixed to the surface of the bag 30 or may be fixed to the upper portion 52 of the hub 50. According to one embodiment, the first half of the hook and loop fastener is approximately 10 cm (4 inches) by 15 cm (6 inches) square and may be interconnected to the PED 12 such that the first half is not centered on the PED 12. Accordingly a user may couple the bag 30 to the PED 12 in any desired position to achieved any desired orientation and angle, for example a centered position, a landscape orientation position, a portrait orientation position, etc.

The construction and arrangement of the elements of the holding apparatus as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. The elements and assemblies may be constructed from any of a wide variety of materials that provide sufficient strength or durability, in any of a wide variety of colors, textures, and combinations. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. An apparatus for holding a personal electronic device, comprising:
a holder configured to be fixed to the personal electronic device; and
a flexible container adapted to be closed and interconnected to the holder.

2. The apparatus of claim 1 further comprising a hub having a first side rotatably coupled to the holder and a second side coupled to the flexible container.

3. The apparatus of claim 1, wherein the hub couples to the holder at an off-center position.

4. The apparatus of claim 1, wherein the flexible container has a first dimension extending normal to the personal electronic device and a second dimension transverse to the first dimension, and wherein the first dimension is at least one-half of the second dimension.

5. The apparatus of claim 4, wherein the flexible container is substantially spherical.

6. The apparatus of claim 1, wherein the apparatus has a weight greater than or substantially equal to a weight of the personal electronic device.

7. The apparatus of claim 1, wherein the flexible container is formed of a substantially inelastic material.

8. The apparatus of claim 1, wherein the holder comprises a first lip and a second lip, and wherein the holder is configured to be fixed to the personal electronic devices by coupling the first lip to a first edge of the personal electronic device and coupling the second lip to a second edge of the personal electronic device.

9. An apparatus for holding a personal electronic device, comprising:
a bag defining an opening and filled with a plurality of pellets; and
a hub coupled to the bag and having a fin extending axially therefrom;
wherein the fin is at least partially immersed in the plurality of pellets.

10. The apparatus of claim 9 further comprising a second fin.

11. The apparatus of claim 10, wherein the first fin extends in a first radial direction, and the second fin extends in a second radial direction.

12. The apparatus of claim 9, wherein the pellets are substantially non-spherical.

13. The apparatus of claim 9, wherein the pellets within the bag inhibit movement of the fin.

14. The apparatus of claim 9, wherein the hub couples to a holder configured to support a personal electronic device, and wherein when the holder is placed in a desired position, a reaction force exerted by plurality of pellets on the fin inhibits motion of the holder from the desired position.

15. An apparatus for holding a personal electronic device, comprising:
a holder configured to be fixed to the personal electronic device;
a bag; and
a hub having a first portion rotatably coupled to the holder and a second portion coupled to the bag.

16. The apparatus of claim 15, wherein hub rotates about an axis parallel to and spaced apart from an axis passing through the center of the personal electronic device.

17. The apparatus of claim 15, wherein the holder comprises a first cam surface, and the hub comprises a second cam surface configured to engage the first cam surface.

18. The apparatus of claim 17, wherein at least one of the first cam surface and the second cam surface includes at least two detent positions.

19. The apparatus of claim 17, wherein the first cam surface comprises a first set of at least three lobes, and the second cam surface comprises a second set of at least three lobes configured to engage the first set of at least three lobes to form at least three detent positions.

20. The apparatus of claim 19, wherein the at least three detent positions comprise a landscape position configured to support the personal electronic device in a landscape orientation and a portrait position configured to support the personal electronic device in a portrait orientation
